(19) United States
(12) Patent Application Publication
(10) Pub. No.: US 2002/0068264 A1
(43) Pub. Date: Jun. 6, 2002

(54) Method and apparatus for facilitating a peer review process for computer-based quizzes

(76) Inventors: Jinglin Gu, Sunnyvale, CA (US); Tara L. McLaughlin, San Mateo, CA (US); Brandy Altstadter, Fremont, CA (US)

Correspondence Address: PARK, VAUGHAN & FLEMING LLP, 508 SECOND STREET, SUITE 201, DAVIS, CA, 95616, US

(21) Appl. No.: 09/729,741

(22) Filed: Dec. 4, 2000

(51) Int. Cl. G09B 7/00

(52) U.S. Cl. 434/323

(57) ABSTRACT

One embodiment of the present invention provides a system that facilitates grading of a quiz on a computer system by a human grader. This system operates by receiving responses to the quiz from at least one person taking the quiz, and then storing the responses for later retrieval. Next, upon receiving a request from a grader to grade the responses to the quiz, the system retrieves the responses, and displays them to the grader on a computer display. The system then receives receiving grading results from the grader, and associates the grading results with the responses. In one embodiment of the present invention, the system displays the responses ordered by question, so that for a given question, responses to the given question are displayed together, thereby enabling the grader to grade all responses to the given question before grading another question. In a variation on this embodiment, the responses are displayed so that the grader does not know the identity of a person who answered a given question. In one embodiment of the present invention, the system displays the responses ordered by person, so that for a given person taking the quiz, responses to questions answered by the given person are displayed together. This enables the grader to grade all responses for the given person before grading responses for another person.

### BACKGROUND

1. Field of the Invention

The present invention relates to computer-based quizzes. More particularly, the present invention relates to a method and an apparatus for facilitating grading of computer-based quizzes.

2. Related Art

The recent proliferation of computer technology has made it possible to automate many tasks involving the manipulation of information. In particular, computers can automate the process of administering educational quizzes and examinations by making a quiz or an examination available on line. This provides a number of advantages.

Making a quiz available on line reduces paperwork by eliminating the time-consuming process of copying the quiz onto sheets of paper to distribute to students. Furthermore, computer technology can automate the process of preparing and formatting the quiz before it is distributed.

Making a quiz available on line allows students to more easily take the quiz. If a quiz is made available across a computer network, such as the Internet, it is possible for students to take the quiz from different geographical locations. Making a quiz available on line also allows students to take the quiz at different times.

Furthermore, making a quiz available on line can automate the process of grading student responses. Unfortunately, many types of questions cannot be automatically graded. For example, essay questions and short answer questions typically require a human grader to read the responses in order to evaluate the performance of each student on the quiz. However, existing computer-based quiz systems do not provide an efficient mechanism for facilitating grading by a human grader.

What is needed is a method and an apparatus for facilitating grading of computer-based quizzes by a human grader.

### SUMMARY

One embodiment of the present invention provides a system that facilitates grading of a quiz on a computer system by a human grader. This system operates by receiving responses to the quiz from at least one person taking the quiz, and then storing the responses for later retrieval. Next, upon receiving a request from a grader to grade the responses to the quiz, the system retrieves the responses, and displays them to the grader on a computer display. The system then receives receiving grading results from the grader, and associates the grading results with the responses.

In one embodiment of the present invention, the system displays the responses ordered by question, so that for a given question, responses to the given question are displayed together, thereby enabling the grader to grade all responses to the given question before grading another question. In a variation on this embodiment, the responses are displayed so that the grader does not know the identity of a person who answered a given question.

In one embodiment of the present invention, the system displays the responses ordered by person, so that for a given person taking the quiz, responses to questions answered by the given person are displayed together. This enables the grader to grade all responses for the given person before grading responses for another person.

In one embodiment of the present invention, the system allows the grader to select between grading by question and grading by student.

In one embodiment of the present invention, the system allows the grader to assign bonus points beyond points allocated for non-bonus questions within the quiz.

In one embodiment of the present invention, the system receives textual comments from the grader in addition to scores.

In one embodiment of the present invention, the system displays the responses to the grader by sending the responses across a network to a grader computer system operated by the grader, and then displaying the responses on the computer display of the grader computer system.

In one embodiment of the present invention, the system makes the grading results available to people taking the quiz.

In one embodiment of the present invention, the system provides a visual indication to the grader that allows the grader to differentiate between questions that have been graded and questions that have not been graded.

### BRIEF DESCRIPTION OF THE FIGURES

FIG. 1 illustrates a number of computer systems coupled together by a network in accordance with an embodiment of the present invention.

FIG. 2 illustrates the structure of a web site for administering, taking and grading quizzes in accordance with an embodiment of the present invention.

FIG. 3 illustrates data structure involves in storing quiz sessions and corresponding responses in accordance with an embodiment of the present invention.

FIG. 4 is a flow chart illustrating the quiz grading process in accordance with an embodiment of the present invention.

FIG. 5 illustrates a user interface for grading by question in accordance with an embodiment of the present invention.

FIG. 6A illustrates a portion of a user interface for grading by student in accordance with an embodiment of the present invention.

FIG. 6B illustrates another portion of a user interface for grading by student in accordance with an embodiment of the present invention.

FIG. 6C illustrates yet another portion of a user interface for grading by student in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

### Computer Systems

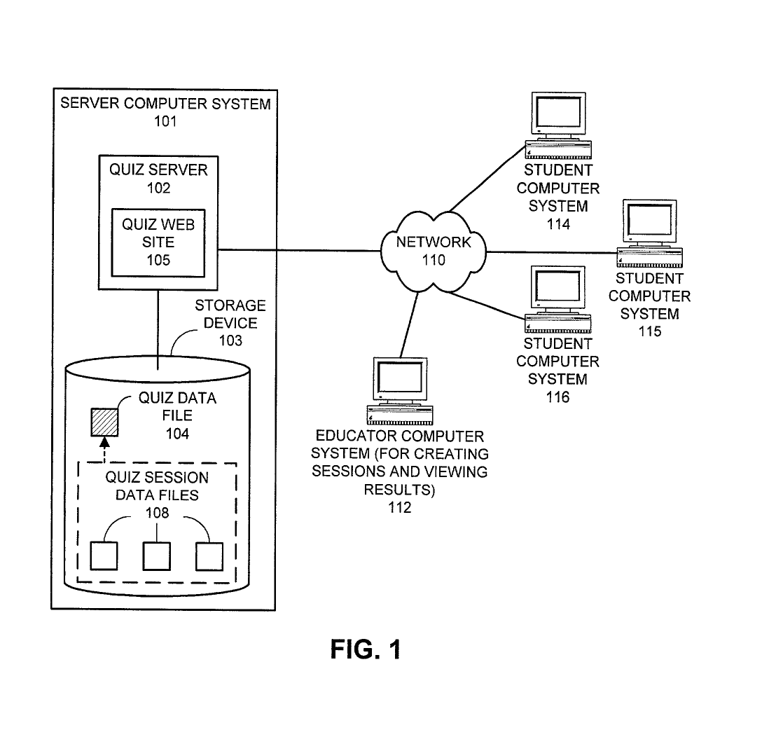

FIG. 1 illustrates a number of computer systems coupled together by a network 110 in accordance with an embodiment of the present invention. These computer systems include server computer system 101, educator computer system 112 and student computer systems 114-116. Network 110 may include any type of wire or wireless link between computers including, but not limited to, a local area network, a wide area network, or a combination of networks. In one embodiment of the present invention, network 110 includes the Internet.

Server computer system 101 may include any node on network 110 including computational capability and data storage capability, as well as a mechanism for servicing requests from clients for computational and data storage resources.

Educator computer system 112 and student computer systems 114-116 may include any node on a network including computational capability and including a mechanism for communicating across network 110. In the embodiment of the present invention illustrated in FIG. 1, educator computer system 112 and student computer systems 114-116 act as clients for server computer system 101. In general, educator computer system 112 communicates with server computer system 101 to enable an educator to create a session for a quiz and to review results generated by students in taking the session.

Correspondingly, student computer systems 114-116 communicate with server computer system 101 to enable students to take quiz sessions. Note that the term educator can generally refer to a teacher or any other person who is in charge of administering a quiz session.

Server computer system 101 includes quiz server 102 and storage device 103. Quiz server 102 includes resources that implement quiz web site 105. Quiz web site 105 provides resources that allow an educator operating on educator computer system 112 to create a quiz session and to view results of the quiz session through a web browser on educator computer system 112. Quiz web site 105 also provides resources that enable students on student computer systems 114-116 to take a quiz session via web browsers on student computer systems 114-116.

Note that although the present invention is described in terms of a web site 105 on a server computer system 101 and web browsers on client computer systems 112 and 114-116, the present invention can generally be implemented on any computer system. Hence, the present invention is not limited to systems designed around web sites or client-server systems.

Storage device 103 may include any type of storage device for storing code and/or data in for access by quiz server 102. For example, storage device 103 may include a disk drive or a semiconductor memory. Storage device 103 includes quiz data files 104. Quiz data files 104 include data associated with a specific quiz. Note that the specific quiz can be associated with a number of different sessions, and these sessions have their own data files. Hence, quiz data files 104 for a specific quiz can be associated with session data files 108 for a number of different sessions.

During operation, the system illustrated in FIG. 1 operates generally as follows. An educator operating on educator computer system 112 creates a session for a quiz from by accessing quiz web site 105 on server computer system 101. This involves first identifying an existing quiz and creating a session for the quiz. (Also note that quiz web site 105 allows an educator to create a quiz.) Next, a number of students take the session for the quiz by accessing quiz web site 105 through student computer systems 114-116. In doing so, the students are able to review their results from the quiz. After all of the students have taken the quiz, the educator can view results of the quiz and can grade the quiz from educator computer system 112.

### Web Site

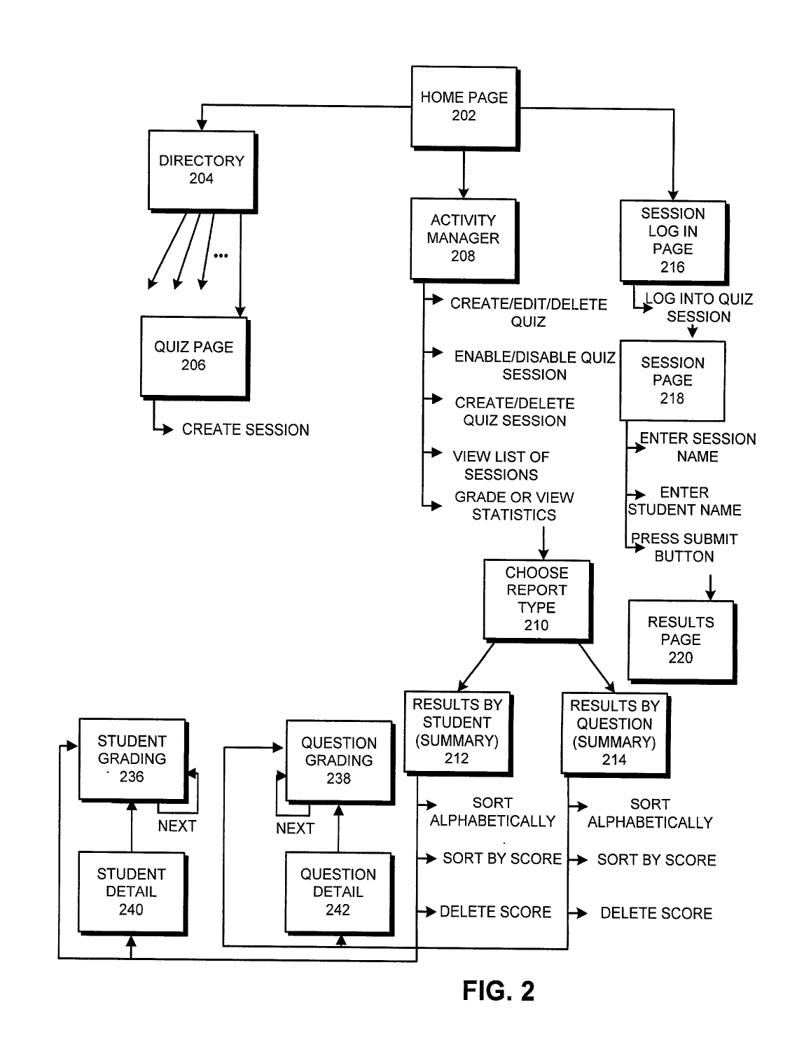

FIG. 2 illustrates the structure of quiz web site 105 (from FIG. 1) for administering and taking and grading quizzes in accordance with an embodiment of the present invention. Users typically enter quiz web site 105 through home page 202, which is accessible through a link on the Internet. Home page 202 includes instructions on how to use quiz web site 105 as well as access points that allow a user to access other pages within quiz web site 105, including directory 204, activity manager 208 and session login page 216.

Directory 204 includes a directory of the quizzes that are available on quiz web site 105. This allows a user to navigate through the quizzes on quiz web site 105 in order to find a desired quiz. Note that directory 204 can be organized hierarchically so that quizzes can be viewed by category and subcategory. In general any type of access structure for viewing quizzes can be used to implement directory 204. In FIG. 2, directory 204 references quiz page 206.

Quiz page 206 allows an educator to view an associated quiz. One of the command options on quiz page 206 allows an educator to create a session for a quiz. Once the session is created, the educator can allow a selected group of students to take the session for the quiz. The results generated by the students in taking the session of the quiz can then be viewed by the instructor. Hence, a session allows a number of different educators to give the same quiz to a number of different groups of students without the results from the different groups of students becoming intermixed.

Educators typically access quiz web site 105 through activity manager 208. Activity manager 208 is password protected for each educator and can be customized for each educator. Activity manager 208 allows an educator to perform a number of functions related to sessions and quizzes. A first set of command options allows the educator to create, edit and delete a quiz. A second set of command options allows the educator to enable and disable specific quiz sessions. A third set of command options allows the educator to create, edit and delete quiz sessions. A fourth set of command options allows the educator to view a list of quiz sessions that the educator has created. A fifth set of command options allows the educator to grade quiz sessions, or to view results from students taking quiz sessions.

In order to view statistics, the educator must first choose a report type (page 210). The educator is then presented with a summary of results organized by students 212 or a summary of results organized by questions 214 depending upon which type of report is chosen. The educator can then perform a number of functions within each type of report, such as sorting alphabetically, sorting by score or deleting a particular score. The educator can also view the results in detail organized by student 240, or can view the results in detail organized by question 242. The educator can additionally choose to perform student grading 236 or to perform question grading 242.

Session login page 216 allows a student to log in to a specified session. Typically, the student receives a session identifier from the educator, and the student uses the session identifier to access the session.

Once the student logs into the session, the student is presented with a session page 218. Session page 218 allows the student to enter his or her name or some other form of identification. Session page 218 then presents questions to the student and allows the student to answer the questions. When the questions are answered, the student presses a submit button within session page 218. The student is then presented with a results page 220. Results page 220 allows the student to view the results of the quiz session including the correct answers to questions that were answered incorrectly.

Note that many other possible organizations for a quiz web site 105 can be used with the present invention. Also note that in one embodiment of the present invention, quiz web site 105 includes mechanisms to implement other computer-based instructional games in addition to quizzes.

### Data Structures

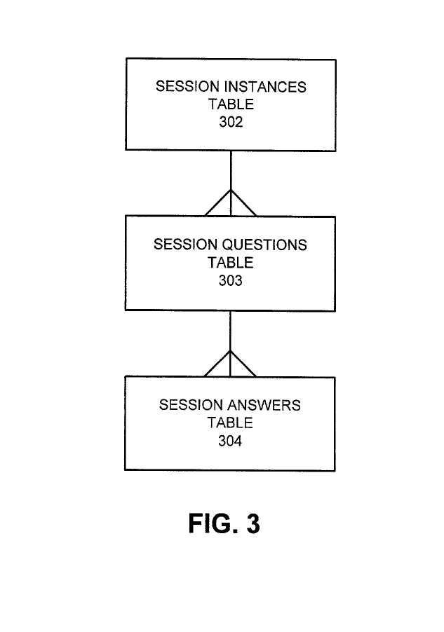

FIG. 3 illustrates data structure involved in storing quiz sessions and corresponding responses in accordance with an embodiment of the present invention. FIG. 3 includes three database tables, including session instance table 302, session questions table 303 and session answers table 304. Session instance table 302 contains a row for each student taking a specific quiz session. Each row of session instance table 302 is associated with multiple rows in session questions table 303. Note that session questions table 303 contains one row for each student and question combination. Finally, session answers table 304 includes a row containing a corresponding answer for each row in session questions table 303.

### Grading Process

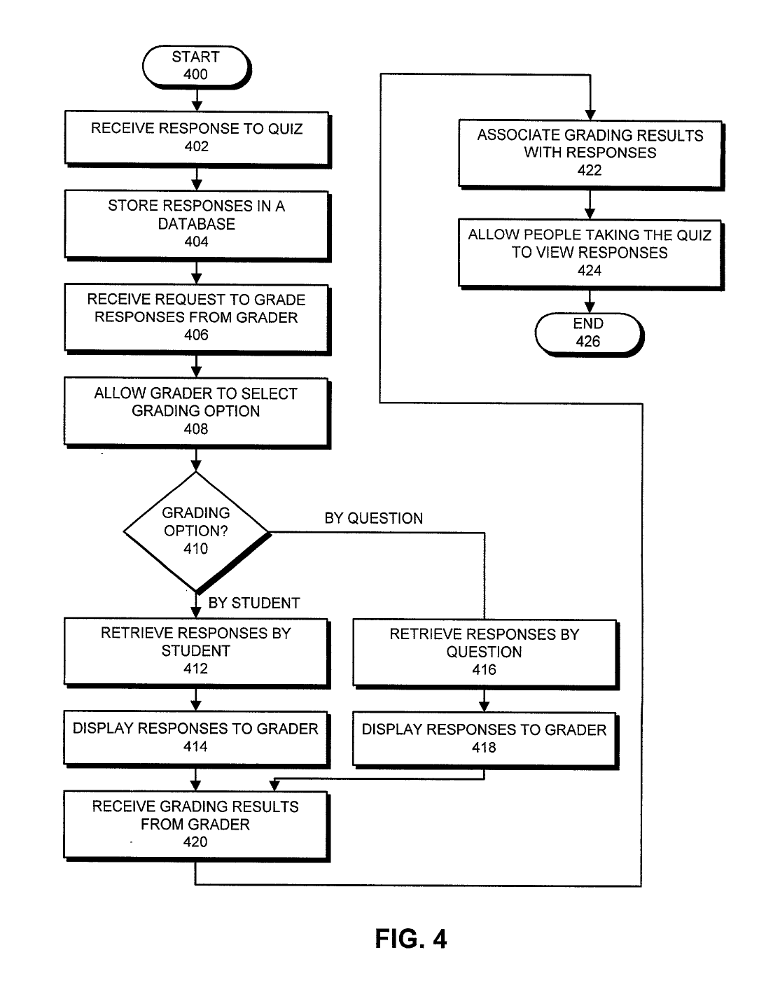

FIG. 4 is a flow chart illustrating the quiz grading process in accordance with an embodiment of the present invention. The system first receives responses from various students taking the quiz (step 402), and the responses are stored in a database or some other type of computer memory (step 404). This process is described in more detail in a pending U.S. patent application entitled “Method and Apparatus for Providing Sessions for Computer-Based Quizzes,” by inventor Paul B. Mishkin, Ser. No. 09/401,067 filed on Sep. 22, 1999, which is hereby incorporated by reference in order to describe the quiz-taking process.

Next, the system receives a request from a grader to grade the responses, possibly from educator through educator computer system 112 (step 406). If the grader has the authority to grade the quiz, the system allows the grader to select between grading by student and grading by question (step 408).

If the grader selects to grade by student, the system retrieves (step 412) and displays (step 414) responses to the grader by student, which means that all responses for a specific student are retrieved and displayed to the grader before responses for a subsequent student are displayed to the grader.

If the grader selects to grade by question, the system retrieves (step 416) and displays (step 418) responses to the grader by student, which means that all responses for a specific question are retrieved and displayed to the grader before responses for another question are displayed to the grader. Note that student identities can be hidden from the grader by associating random numbers with each student instead of student names.

Next, the system receives results from the grader (step 420), and then associates grading results with responses (step 422). This may also involve storing the grading results along with the responses for later retrieval.

The system can also allow people taking the quiz to view the grading results at a later time (step 424).

In one embodiment of the present invention, the system allows some questions to be manually graded while other questions are automatically graded. Note that some questions, such as multiple choice questions and true/false questions, can be easily auto-graded. Whereas, other questions, such as short answer questions or essay questions, are better suited for manual grading. Hence, one embodiment of the present invention first automatically grades some of the questions, and then allows a grader to manually grade other questions. Note that the grader can also manually override the grading for computer-graded questions.

### User Interface

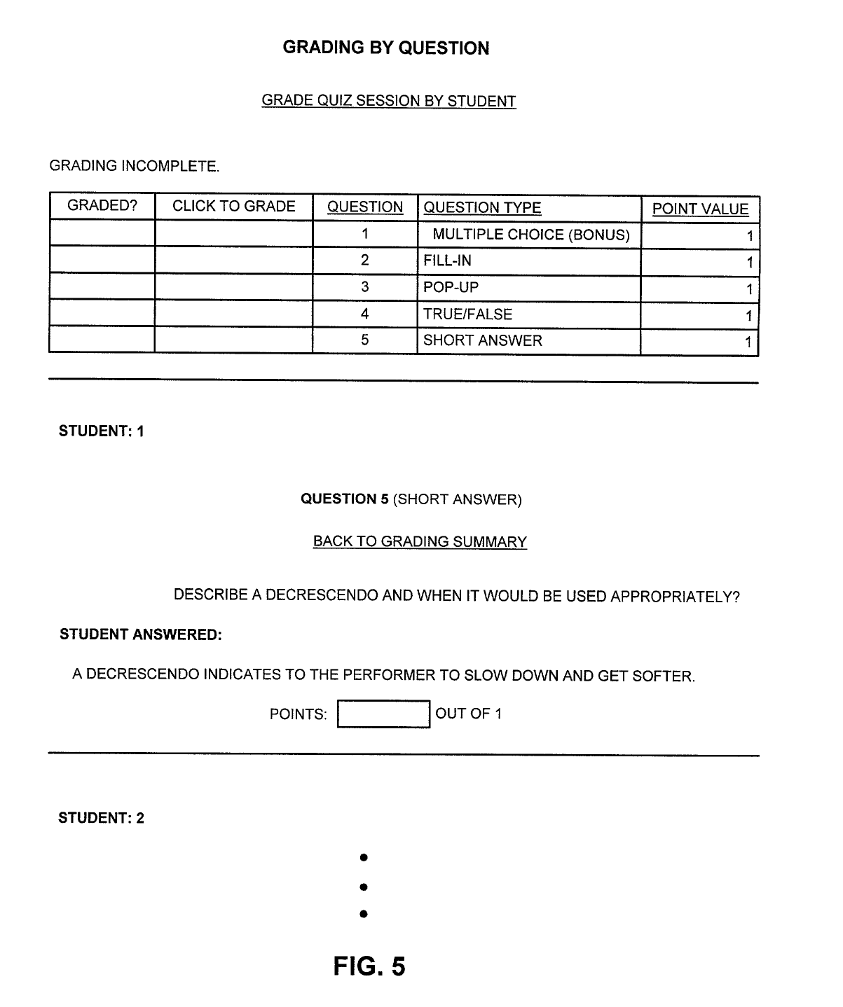

FIG. 5 illustrates a user interface for grading by question in accordance with an embodiment of the present invention. This user interface includes a summary table that enables the grader to select specific questions to grade. When a question is selected, the grader is presented with responses for each student in sequence. Note that the students are only identified by a student number, not by name. When all responses for a specific question are graded, the system places a check mark in a box within this table to inform the grader that the question has been graded.

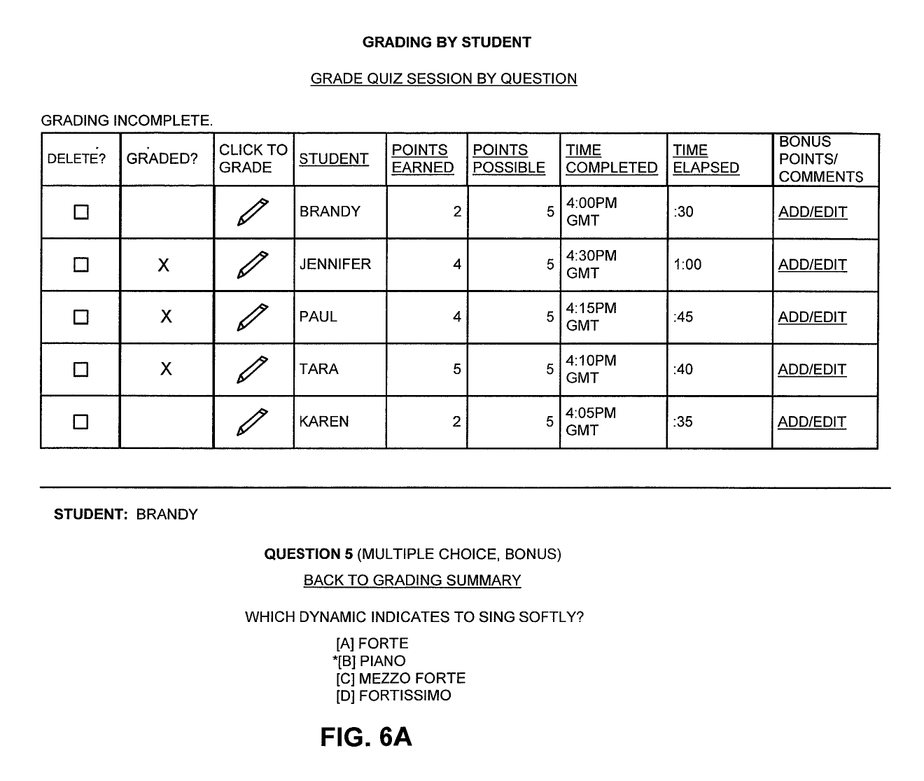

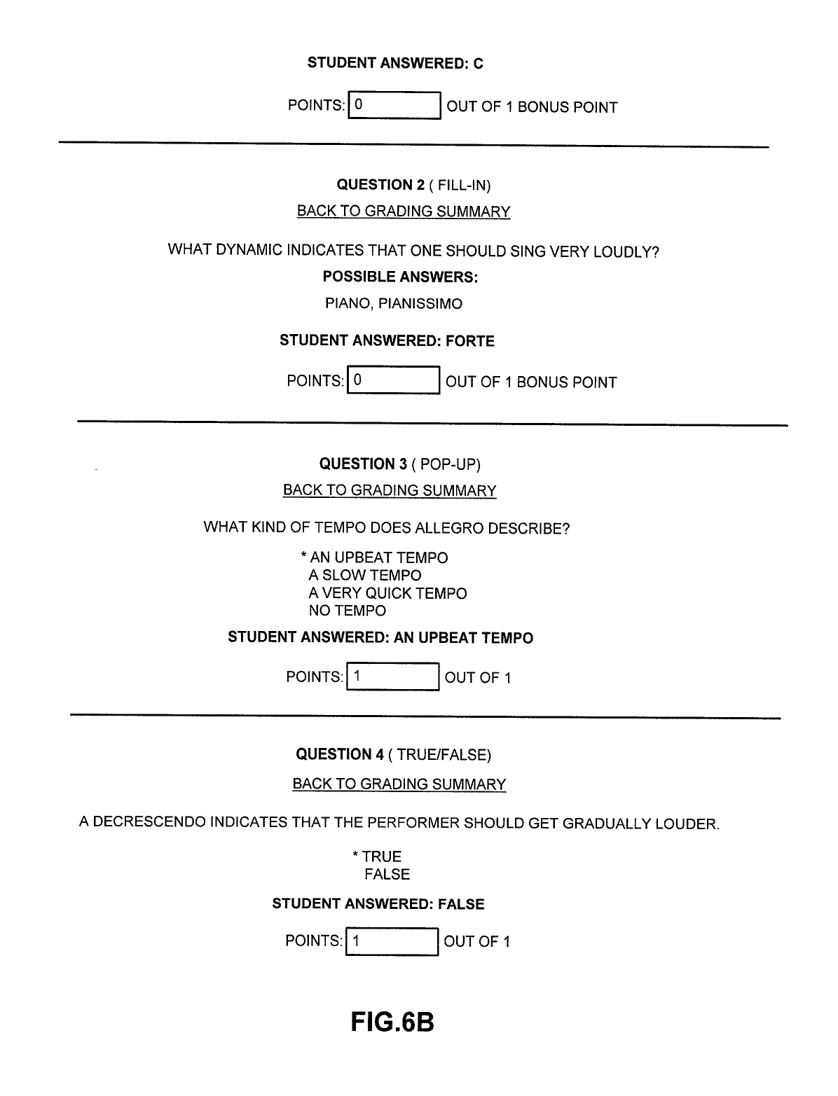

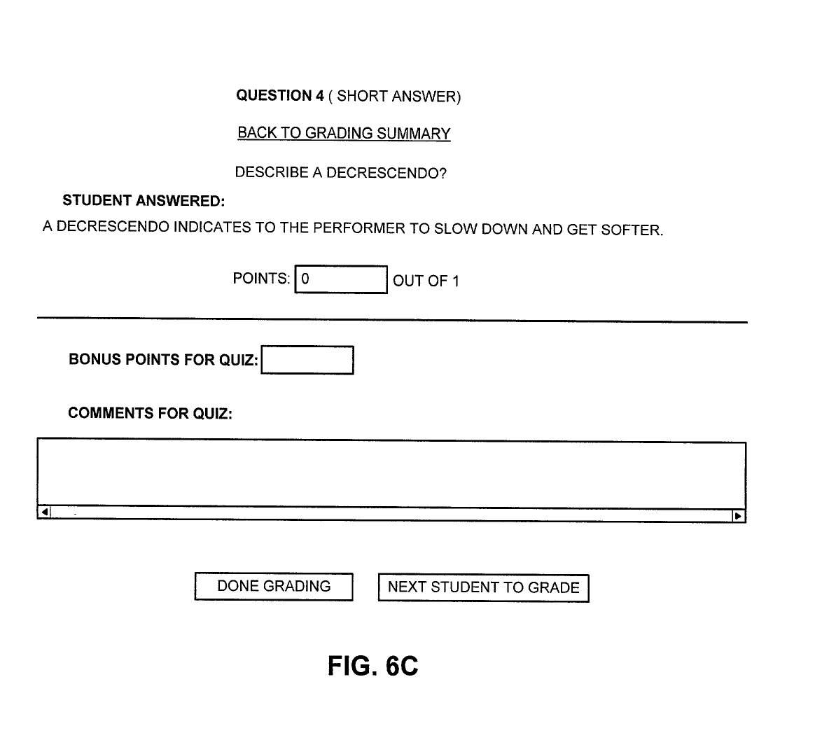

FIGS. 6A-6C illustrates a user interface for grading by student in accordance with an embodiment of the present invention. This user interface includes a summary table that enables the grader to select students to grade. When a specific student is selected, the grader is presented with responses for the specific student to all of the questions on the quiz. When all responses for the specific student are graded, the system places a check mark in a box within this table to inform the grader that the student has been graded. Note that the grader can also assign bonus points for the quiz and can also input textual comments as feedback to the student.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating grading of a quiz on a computer system, comprising:
receiving responses to the quiz from at least one person taking the quiz;
storing the responses;
receiving a request from a grader requesting to grade the responses to the quiz;
retrieving the responses;
displaying the responses to the grader on a computer display;
receiving grading results for the responses from the grader; and
associating the grading results with the responses.

2. The method of claim 1, wherein displaying the responses to the quiz involves displaying the responses ordered by question, so that for a given question, responses to the given question are displayed together, thereby enabling the grader to grade all responses to the given question before grading another question.

3. The method of claim 2, wherein the responses to the quiz are displayed so that the grader does not know the identity of a person who answered a given question.

4. The method of claim 1, wherein displaying the responses to the quiz involves displaying responses ordered by person, so that for a given person taking the quiz, responses to questions answered by the given person are displayed together, thereby enabling the grader to grade all responses for the given person before grading responses for another person.

5. The method of claim 1, further comprising allowing the grader to select between grading by question and grading by student.

6. The method of claim 1, further comprising allowing the grader to assign bonus points beyond points allocated for non-bonus questions within the quiz.

7. The method of claim 1, wherein receiving grading results from the grader involves receiving textual comments from the grader in addition to scores.

8. The method of claim 1, wherein displaying the responses to the grader involves:
sending the responses across a network to a grader computer system operated by the grader; and
displaying the responses on the computer display of the grader computer system.

9. The method of claim 1, further comprising making the grading results available to the at least one person taking the quiz.

10. The method of claim 1, further comprising providing a visual indication to the grader that allows the grader to differentiate between questions that have been graded and questions that have not been graded.

11. A computer-readable storage medium storing instructions that when executed by a computer cause the computer to perform a method for facilitating grading of a quiz on a computer system, the method comprising:
receiving responses to the quiz from at least one person taking the quiz;
storing the responses;
receiving a request from a grader requesting to grade the responses to the quiz;
retrieving the responses;
displaying the responses to the grader on a computer display;
receiving grading results for the responses from the grader; and
associating the grading results with the responses.

12. The computer-readable storage medium of claim 11, wherein displaying the responses to the quiz involves displaying the responses ordered by question, so that for a given question, responses to the given question are displayed together, thereby enabling the grader to grade all responses to the given question before grading another question.

13. The computer-readable storage medium of claim 12, wherein the responses to the quiz are displayed so that the grader does not know the identity of a person who answered a given question.

14. The computer-readable storage medium of claim 11, wherein displaying the responses to the quiz involves displaying responses ordered by person, so that for a given person taking the quiz, responses to questions answered by the given person are displayed together, thereby enabling the grader to grade all responses for the given person before grading responses for another person.

15. The computer-readable storage medium of claim 11, wherein the method further comprises allowing the grader to select between grading by question and grading by student.

16. The computer-readable storage medium of claim 11, wherein the method further comprises allowing the grader to assign bonus points beyond points allocated for non-bonus questions within the quiz.

17. The computer-readable storage medium of claim 11, wherein receiving grading results from the grader involves receiving textual comments from the grader in addition to scores.

18. The computer-readable storage medium of claim 11, wherein displaying the responses to the grader involves:
sending the responses across a network to a grader computer system operated by the grader; and
displaying the responses on the computer display of the grader computer system.

19. The computer-readable storage medium of claim 11, wherein the method further comprises making the grading results available to the at least one person taking the quiz.

20. The computer-readable storage medium of claim 11, wherein the method further comprises providing a visual indication to the grader that allows the grader to differentiate between questions that have been graded and questions that have not been graded.

21. An apparatus that facilitates grading of a quiz on a computer system, comprising:
a receiving mechanism that is configured to receive responses to the quiz from at least one person taking the quiz;
a data storage area for storing the responses to the quiz;
wherein the receiving mechanism is additionally configured to receive a request from a grader requesting to grade the responses to the quiz; and
a display mechanism that is configured to display the responses to the grader on a computer display;
wherein the receiving mechanism is additionally configured to receive grading results for the responses from the grader.

22. The apparatus of claim 21, wherein the display mechanism is configured to display the responses the quiz ordered by question, so that for a given question, responses to the given question are displayed together, thereby enabling the grader to grade all responses to the given question before grading another question.

23. The apparatus of claim 22, wherein the display mechanism is configured to display the responses to the quiz so that the grader does not know the identity of a person who answered a given question.

24. The apparatus of claim 21, wherein the display mechanism is configured to display the responses ordered by person, so that for a given person taking the quiz, responses to questions answered by the given person are displayed together, thereby enabling the grader to grade all responses for the given person before grading responses for another person.

25. The apparatus of claim 21, further comprising a selection mechanism that is configured to allow the grader to select between grading by question and grading by student.

26. The apparatus of claim 21, further comprising a bonus point mechanism that is configured to allow the grader to assign bonus points beyond points allocated for non-bonus questions within the quiz.

27. The apparatus of claim 21, wherein in the receiving mechanism is configured to receive textual comments from the grader in addition to scores.

28. The apparatus of claim 21, wherein the display mechanism is configured to:
send the responses across a network to a grader computer system operated by the grader; and to
display the responses on the computer display of the grader computer system.

29. The apparatus of claim 21, further comprising an access mechanism that is configured to make the grading results available to the at least one person taking the quiz.

30. The apparatus of claim 21, wherein the display mechanism includes a visual indicator that allows the grader to differentiate between questions that have been graded and questions that have not been graded.
